(19) United States
(12) Patent Application Publication
(10) Pub. No.: US 2006/0001778 A1
(43) Pub. Date: Jan. 5, 2006

(54) Video modulating apparatus including video equalizer

(75) Inventors: Toru Oyama, Tokyo (JP); Tadayuki Shinkai, Tokyo (JP); Toshie Mottate, Tokyo (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/149,666

(22) Filed: Jun. 10, 2005

(30) Foreign Application Priority Data
Jun. 30, 2004 (JP) 2004-194545

(51) Int. Cl. H04N 5/38

(52) U.S. Cl. 348/723

(57) ABSTRACT

A video modulating apparatus modulates a high frequency signal with an input video signal to form a television signal. The video modulating apparatus includes a video equalizer circuit that directly group-delays the input video signal; and a video modulator that modulates the high frequency signal with the video signal group-delayed by the video equalizer circuit.

### BACKGROUND OF THE INVENTION

1. Field of the Invention

The present invention relates to a video modulating apparatus used for a simple television broadcasting signal generating device, and more particularly, to a video modulating apparatus capable of obtaining a television broadcasting signal in accordance with a broadcasting standard at a low cost by means of a video equalizer for group-delaying a video signal, when the television broadcasting signal is generated from the video signal.

2. Description of the Related Art

Generally, a video modulating apparatus, which is used for a simple television broadcasting signal generating device, converts a video signal into an intermediate frequency signal which is easily processed, and then up-converts it to obtain a desired television signal. At this time, it has been known that a group delaying circuit is additionally inserted into a VSB filter and an SAW filter provided at a rear stage of an intermediate frequency amplifier in order to group-delay the video signal in accordance with the broadcasting standard.

FIG. 4 is a block diagram showing an example of a structure of a video modulating apparatus of a related art, which is disclosed as a video modulating apparatus of a television signal broadcasting apparatus in Japanese Unexamined Patent Application Publication No. 2002-281401.

As shown in FIG. 4, the video modulating apparatus includes a video signal amplifier 31, a video modulator 32, a first carrier signal generator 33, an intermediate frequency signal amplifier 34, a group delay time correcting circuit 35, a surface acoustic wave (SAW) filter 36, an up-converter 37, a second carrier signal generator 38, a video signal inputting terminal 39, and a broadcasting signal outputting terminal 40.

In this case, when the video signal and a first carrier signal are frequency-mixed at the video modulator 32, a first carrier signal frequency generated from the first carrier signal generator 33 is selected to become a frequency in which an intermediate frequency signal can be extracted from the frequency-mixed signal. Further, when the intermediate frequency signal and a second carrier signal are frequency-mixed at the up-converter 37, a second carrier signal frequency generated from the second carrier signal generator 38 is selected to become a frequency in which a television broadcasting signal can be extracted from the frequency-mixed signal, that is, a frequency higher than the first carrier signal frequency.

In addition, the video signal amplifier 31 has an input terminal connected to the video signal inputting terminal 39 and an output terminal connected to a first input terminal of the video modulator 32. The video modulator 32 has a second input terminal connected to an output terminal of the first carrier signal generator 33 and an output terminal connected to an input terminal of the intermediate frequency signal amplifier 34. The group delay signal correcting circuit 35 has an input terminal connected to an output terminal of the intermediate frequency signal amplifier 34 and an output terminal connected to an input terminal of the surface acoustic wave (SAW) filter 36. The up-converter 37 has a first input terminal connected to an output terminal of the SAW filter 36, a second input terminal connected to an output terminal of the second carrier signal generator 38, and an output terminal connected to the broadcasting signal outputting terminal 40.

The operation of the video modulating apparatus having the above-mentioned structure is as follows. When the video signal is inputted to the video signal inputting terminal 39, the video signal is amplified to a signal having a predetermined signal level at the video signal amplifier 31, and the amplified video signal is inputted to the video modulator 32 through the first input terminal of the video modulator. At this time, the first carrier signal outputted from the first carrier signal generator 33 is supplied to the second input terminal of the video modulator 32, the first carrier signal and the video signal are AM-modulated at the video modulator 32, and the modulated signal is outputted through the output terminal of the video modulator 32. When the modulated signal is inputted to the intermediate frequency signal amplifier 34, only an intermediate frequency signal component is selectively amplified at the intermediate frequency signal amplifier 34, and the amplified intermediate frequency signal is supplied to the group delay time correcting circuit 35.

Since the group delay time correcting circuit 35 corrects a deviation of a group delay time in an intermediate frequency signal band in the SAW filter 36 located at the next stage, which has the characteristics that attenuates a frequency signal level equal to or higher than those of the intermediate frequency signal band. Therefore, the group delay time correcting circuit 35 corrects the deviation of the group delay time in the intermediate frequency signal band, and the corrected intermediate frequency signal is supplied to the SAW filter 36. The surface acoustic filter 36 has the frequency characteristics and the group delay time characteristics for applying the residual sideband characteristics necessary for the television broadcasting signal with respect to the supplied intermediate frequency signal, and the intermediate frequency signal to which the residual sideband characteristic is applied is supplied to the up-converter 37 through the first input terminal of the surface acoustic filter 36. At this time, the second carrier signal outputted from the second carrier signal generator 38 is supplied to the second input terminal of the up-converter 37, the second carrier signal and the intermediate frequency signal are frequency-mixed at the up-converter 37, the television broadcasting signal is outputted through the output terminal of the up-converter 37, and the broadcasting signal is supplied to an utilization circuit (not shown in FIG. 4) through the broadcasting signal output terminal 40.

The video modulating apparatus having the above-mentioned structure performs various signal processes such that the frequency mixing are performed twice with respect to the video signal at the video modulator 32 and the up-counter 37, the group delay time correcting circuit 35 corrects the deviation of the group delay time with respect to the intermediate frequency signal, and the surface acoustic filter 36 applies the residual sideband characteristics to the intermediate frequency signal. Thus, it is necessary for the surface acoustic filter 36 to be provided in each of the first and second carrier signal generators 33 and 38 and the group delay time correcting circuit 35. As a result, in a case in which the a simple television signal generator is formed by using the video modulating apparatus, there is a problem in that the number of constituent elements for the video modulating apparatus increases, the mounting volume increases, and the manufacturing cost increases.

### SUMMARY OF THE INVENTION

Accordingly, the present invention has been made to solve the above problems, and it is an object of the present invention to provide a video modulating apparatus having less components at a low manufacturing cost, in which a video signal is directly group-delayed through a video equalizer circuit and then the video signal is frequency-converted once to form a video modulating signal.

According to a first aspect of the present invention, there is provided a video modulating apparatus which modulates a high frequency signal with an input video signal to form a television signal, including: a video equalizer circuit that directly group-delays the input video signal; and a video modulator that modulates the high frequency signal with the video signal group-delayed by the video equalizer circuit.

Further, according to another aspect of the invention, the video equalizer circuit includes a front transistor and a rear transistor; a capacitor connected between a collector of the front transistor and a base of the rear transistor; and a resistor connected between an emitter of the front transistor and a base of the rear transistor, and the video equalizer circuit inputs the video signal to the base of the front transistor and extracts the video signal group-delayed from the emitter of the rear transistor.

### BRIEF DESCRIPTION OF THE DRAWINGS

FIG. 1 is a block diagram illustrating a structure of essential elements of a video modulating apparatus according to an embodiment of the invention;

FIG. 2 is a circuit diagram specifically illustrating an example of a structure of a video equalizer circuit used for a video modulating apparatus shown in FIG. 1;

FIG. 3 is a diagram illustrating an example of group delay characteristics obtained by the video equalizer circuit shown in FIG. 2; and

FIG. 4 is a block diagram illustrating an example of a structure of a known video modulating apparatus.

### DESCRIPTION OF THE PREFERRED EMBODIMENT

Hereinafter, preferred embodiments of the present invention will be described with reference to the accompanying drawings.

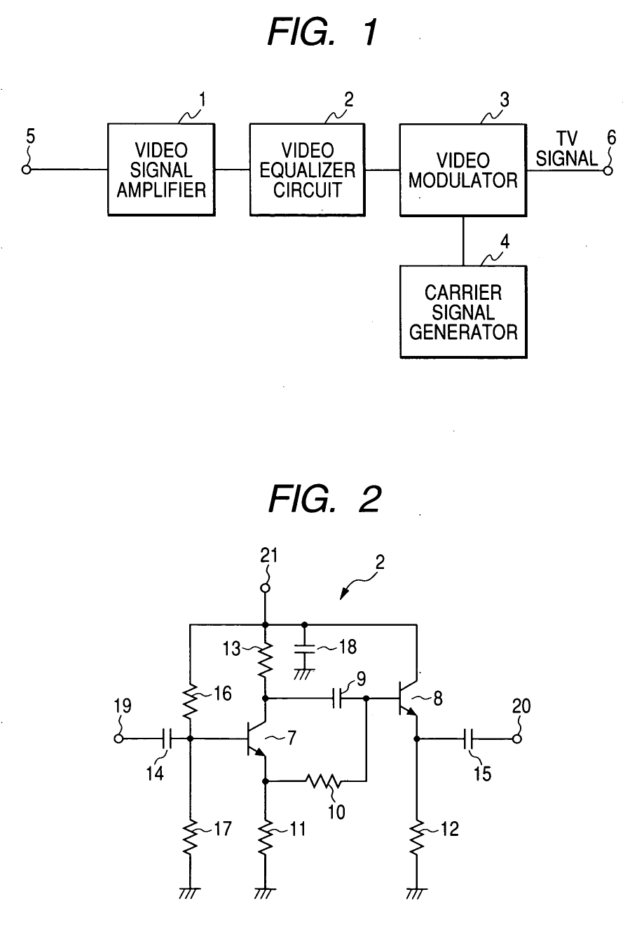

FIG. 1 is a block diagram illustrating a structure of essential elements of a video modulating apparatus according to an embodiment of the invention.

As shown in FIG. 1, the video modulating apparatus according to the embodiment of the invention includes a video signal amplifier 1, a video equalizer circuit 2, a video modulator 3, a carrier signal generator 4, a video signal input terminal 54, and a signal output terminal 6.

In this case, a desired television signal frequency is selectively generated from the carrier signal generator 4 to be input into the video modulator 3. Here, a carrier wave is directly modulated with a video signal to be output as a television signal.

In addition, the video signal amplifier 1 has an input terminal connected to the video signal input terminal 5 and an output terminal connected to an input terminal of the video equalizer circuit 2. The video modulator 3 has a first input terminal connected to an output terminal of the video equalizer circuit 2, a second input terminal connected to an output terminal of the carrier signal generator 4, and an output terminal connected to the signal output terminal 6.

Here, the operation of the video modulating apparatus according to the embodiment will be described.

When the video signal is input to the video signal input terminal 5, the video signal is amplified by the video signal amplifier 1 such that it has a predetermined level, and the amplified video signal is supplied to the video equalizer circuit 2. Since the video equalizer circuit 2 performs the same operation as a group delay time correcting circuit 35 used for a known video modulating apparatus shown in FIG. 5, it applies the video equalizer characteristic set in circuits to the supplied video signal and then supplies the equalized video signal to the video modulator 3 through the first input terminal. At this time, the video modulator 3 is supplied with the carrier signal outputted from the carrier signal generator 4 through the second input terminal, modulates the carrier signal by the video signal, and generates a television signal. The television broadcasting signal outputted from the video modulator 3 is supplied to a utilization circuit (not shown in FIG. 1), such as a television, through the signal output terminal 6.

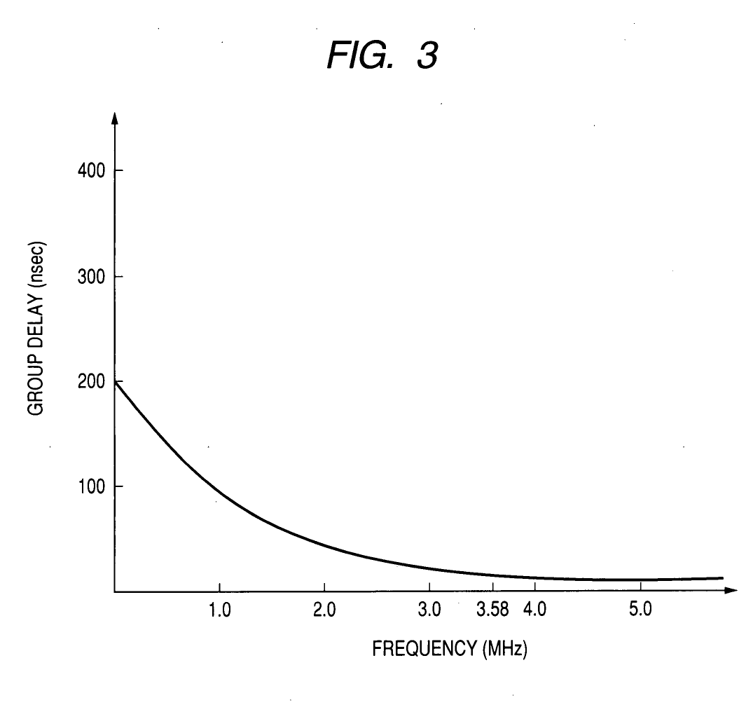

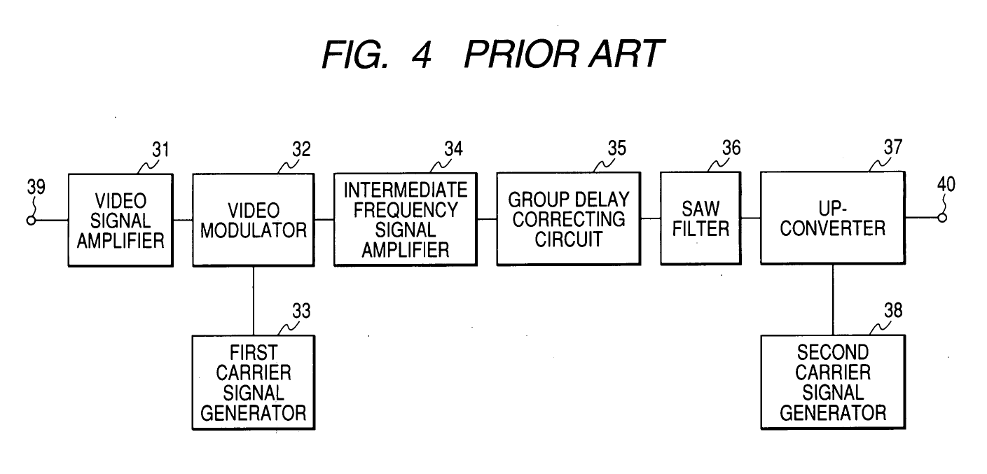

Next, FIG. 2 is a circuit diagram specifically illustrating an example of a structure of the video equalizer circuit 2 used for the video modulating apparatus shown in FIG. 1, and FIG. 3 is a diagram illustrating an example of group delay characteristics obtained by the video equalizer circuit 2 shown in FIG. 2.

As shown in FIG. 2, the video equalizer circuit 2 includes a front transistor 7, a rear transistor 8, a capacitor 9 connected between a collector of the front transistor 7 and a base of the rear transistor 8, a resistor 10 connected between an emitter of the front transistor 7 and the base of the rear transistor 8, an emitter resistor 11 of the front transistor 7, an emitter load resistor 12 of the rear transistor 8, a collector resistor 13 of the front transistor 7, a first coupling capacitor 14 connected between the base of the front transistor 7 and the input terminal 19, a second coupling capacitor 15 connected between the emitter of the rear transistor 8 and the output terminal 20, base bias resistors 16 and 17 of the front transistor 7, and a bypass capacitor 18 connected between a power supply terminal and a ground.

In this case, a resistance value of the emitter resistor 11 of the front transistor 7 and a resistance value of the collector resistor 13 of the front transistor 7 are selected to be equal to each other, and an amplitude value of a signal generated at both ends of the emitter resistor 11 and an amplitude value of a signal generated at both ends of the collector resistor 13 are set so as to have the same absolute value but with opposite polarities. When set in this way, the group delay characteristic of the video signal obtained by the video equalizer circuit 2 is as in FIG. 3. That is, according to the group delay characteristic of the video equalizer circuit 2, in a frequency range in which a frequency of the video signal is equal to or greater than 4.0 MHz, even though the frequency increases, the amount of group delay (GD) has minimal change. However, in a frequency range in which the frequency of the video signal is equal to or less than 4.0 MHz, as the frequency decreases, the amount of group delay (GD) increases exponentially.

In addition, in a case in which the video equalizer circuit 2 having the group delay characteristic is connected to the video signal circuit before modulation and applies the equalizing characteristic accompanying the above-mentioned group delay to the video signal, when the television broadcasting signal is formed by using the video signal, it is possible to form a video modulating signal having the desired characteristics based on the standard from the television broadcasting signal. In addition, by using the video modulating apparatus, the number of constituent elements of the video modulating apparatus can be greatly reduced, and the mounting volume is also reduced. Therefore, it is possible to obtain a video modulating apparatus in which the manufacturing cost is low.

In this case, the video modulating apparatus according to the invention is not limited to one shown in FIG. 1, but a supplementary structure may be added to the basic structure as long as the basic structure is not undermined. For example, a broadcasting signal amplifier may be provided between the video modulator 3 and the signal output terminal 6 such that the television broadcasting signal is selectively amplified. In addition, a buffer amplifier may be provided between the video equalizer circuit 2 and the video modulator 3.

In addition, the video equalizer circuit 2 shown in FIG. 2 is suitable for the structure of the video equalizer circuit 2. However, the video equalizer circuit 2 used in the invention is not limited to the structure illustrated in FIG. 2. That is, if the characteristics which are the same as the group delay characteristics is obtained, another structure may be used.

According to the invention, the video modulating apparatus includes the video equalizer circuit that directly group-delays the input video signal and the video modulator that modulates the high frequency signal with the video signal group-delayed by the video equalizer circuit. Therefore, it is possible to greatly reduce the number of constituent elements of the video modulating apparatus and thusly reduces the mounting volume of the video modulating apparatus without impairing the desired characteristics as the television signal. As a result, it is possible to obtain the video modulating apparatus at low manufacturing cost.

Further, since the general video equalizer circuit is used in the invention, the video modulating apparatus of the invention has effects in which the structure of the circuit can be greatly simplified, the number of constituent elements can be greatly reduced, and the manufacturing cost can be reduced, as compared to a video modulating apparatus having the group delay time correcting circuit or the surface acoustic wave filter.

1. A video modulating apparatus which modulates a high frequency signal with an input video signal to form a television signal, comprising:
a video equalizer circuit that directly group-delays the input video signal; and
a video modulator that modulates the high frequency signal with the video signal group-delayed by the video equalizer circuit.

2. The video modulating apparatus according to claim 1,
wherein the video equalizer circuit includes:
a front transistor and a rear transistor;
a capacitor connected between a collector of the front transistor and a base of the rear transistor; and
a resistor connected between an emitter of the front transistor and the base of the rear transistor, and
the video equalizer circuit inputs the video signal to a base of the front transistor, and extracts the video signal group-delayed from an emitter of the rear transistor.
